(19) United States
(12) Patent Application Publication
(10) Pub. No.: US 2009/0107590 A1
(43) Pub. Date: Apr. 30, 2009

(54) Soft magnetic alloy for microwire casting

(75) Inventor: Eliezer Adar, Sde Varburg (IL)

Correspondence Address: OBLON, SPIVAK, MCCLELLAND MAIER & NEUSTADT, P.C., 1940 DUKE STREET, ALEXANDRIA, VA, 22314, US

(73) Assignee: GLOBAL MICRO WIRE TECHNOLOGIES, LTD., Even Yehuda (IL)

(21) Appl. No.: 12/292,987

(22) Filed: Dec. 2, 2008

Related U.S. Application Data
(63) Continuation of application No. 11/316,738, filed on Dec. 27, 2005, now abandoned.

(51) Int. Cl. C21D 1/00; C22C 45/02; H01F 1/153; C22F 1/00; C22C 45/04; C22C 45/00

(52) U.S. Cl. 148/561; 148/403; 148/304

(57) ABSTRACT

An alloy, which can be used in a microwire, contains 26 to 52 weight % Fe; 26 to 52 weight % Co; 3.0 to 38.0 weight % Ni; at least one selected from the group consisting of 1.0 to 8.0 weight % V, 1.0 to 8.0 weight % Cr, 1.0 to 8.0 weight % Zr, 1.0 to 8.0 weight % Dy and 1.0 to 8.0 weight % Nb; at least one selected from the group consisting of 2.0 to 8.3 weight % Si and 2.0 to 8.3 weight % B; and at least one selected from the group consisting of 0.2 to 1.6 weight % Ce, 0.2 to 1.6 weight % La and 0.2 to 1.6 weight % Y. When cast in a microwire, the alloy can be substantially amorphous.

### BACKGROUND OF THE INVENTION

1. Field of the Invention

This invention relates to high precision alloys. In particular, the present invention relates to amorphous, soft magnetic compositions having various coercive forces and to the use of the compositions in the fabrication of glass-coated microwires by the method of rapid quenching from a liquid phase.

2. Description of the Background

It has been the tendency in modern technologies to demand new materials and processes for their production from material engineering. One of the problems encountered in material engineering is the production of materials having predetermined properties.

It has also been the tendency in modern technologies to demand miniaturization techniques that use new materials. There are various technical solutions in miniaturization technologies that require magnetic microwires. For example, use of amorphous glass-coated microwire allows the sensitivity and precision of various recording and measurement systems to be increased.

Known techniques for casting alloy microwires in glass insulation enables the formation of an amorphous homogeneous structure and “freezing” the alloy in this condition at quenching the material from the liquid phase with the cooling rate of up to 3×10⁶ K/s.

According to the microwire casting techniques, glass tubing containing a desired metal batch is heated to a temperature sufficient to melt the metal and soften the glass. In general, the heating is obtained via electromagnetic induction for melting the metal, which, in turn, softens the glass. The outer glass shell is then drawn out as fine as desired. As a result, two coaxial flows arise: one of the melted metal in the center and another of softened glass around the metal one. After leaving the heating zone, both flows pass through a water stream, for cooling and solidifying. The result is a continuous microwire with the metal being continuously cast as a core covered with a glass coating.

It is known that soft magnetic amorphous materials have the excellent magnetic characteristics. Usually soft magnetic materials have a coercive force from 0.2-100 A/m. There is interest in providing soft magnetic alloys having a wide range of the coercivity in the range of 0.5-1200 A/m in combination with high tensile strength.

Known alloys based on iron and cobalt have a wide range of coercivity, as shown in Table 1.

TABLE 1

| | | Co | | | | Si | Coercivity, |
|---|---|---|---|---|---|---|---|
| Number | Fe | (wt %) | Ni (wt %) | V (wt %) | Cr (wt %) | (wt %) | A/m |
| 1 | Base | 90-93 | | | | | 10-160 |
| 2 | Base | | 35-37 | | 1.8-2.2 | 0.8-1.2 | 6-80 |
| 3 | Base | 25-27 | 35-37 | | 2.8-3.2 | | 3-9 |
| 4 | Base | 48-50 | | 1.3-1.8 | | | 40-250 |
| 5 | Base | 48-50 | | 1.7-2.0 | | | 40-160 |
| 6 | Base | 47.5-48.5 | 4.3-4.6 | 1.3-1.6 | | | 200-600 |

These alloys have a crystalline structure and are usually used as wrought alloys for preparation of long-length and bulky billets. These alloys cannot be used in glass coated microwires because of various physical and chemical interactions between the molten alloy and glass during the microwire casting process. In particular, the wetting ability of these alloys by glass is not sufficient.

Known amorphous Fe-based alloys that can be made in a ribbon shape by the method of rapid quenching are shown in Table 2.

TABLE 2

| | | Co | Ni | Al | Mn | Si | B |
|---|---|---|---|---|---|---|---|
| Number | Fe | (wt %) | (wt %) | (wt %) | (wt %) | (wt %) | (wt %) |
| 1 | base | | 1.2-1.8 | | | 4.9-5.5 | 2.8-3.2 |
| 2 | base | | 9.2-10.0 | | ≦0.1 | 5.0-5.6 | 2.8-3.6 |
| 3 | base | 23-25 | | ≦0.5 | | 2.6-3.2 | 2.8-3.4 |

U.S. Pat. No. 6,352,599 discloses a permanent magnet material characterized by the chemical formula: (RE_{1-y}La_{y})vFe_{100-v-w-x-y}Co_{w}M_{z}Bₓ, where Re is at least one element selected from the group consisting of Pr and Nd, M is Cr, v is from about 9.5 to about 11.5, w is from about 5 to about 12, x is from about 9 to about 11.5, y is from about 0.05 to about 0.1, and z is from about 0.05 to about 3.

The above-mentioned magnetic materials are made by rapid cooling from a molten state at a cooling rate between 10⁴ to 10⁷ degrees C./second to make a substantially amorphous material, followed by a thermal treatment at temperatures from 600-750° C./second for 0.01 second to 120 min.

U.S. Pat. No. 4,657,605 discloses a fine magnetic amorphous metal wire comprising an alloy having the composition formula (Co₁₋ₐFeₐ)_{100-z-y-z}SiₓB_{y}Mn_{z}, where x<20 atomic %, 7 atomic %≦y<35 atomic %, 7 atomic %<x+y≦35 atomic %, 0.1 atomic %≦z≦3 atomic %, and 0.01≦a≦0.1

The alloys shown in Table 2 and disclosed in the '599 and '605 patents are not suitable for a mass microwire manufacturing process because the wetting ability of glasses by the molten alloys is not sufficient and there is insufficient purification of the alloys from entrapped gases and other non-metallic inclusions.

U.S. Pat. No. RE 34,322 discloses a method of preparing a hard magnetic polycrystalline structure. The method of preparing this structure comprising the steps of forming an amorphous alloy and heating this alloy to form a polycrystalline structure. Amorphous alloy can be obtained from transition metal-boron-lanthanide alloys. These alloys are represented by the formula: (M_{w}XₓB_{1-w-x})_{1-y}(YᵥR₂L_{1-x-z})_{y}, where v is 0 to 0.8; w is from about 0.7 to about 0.98; x is from 0 to about 0.15; y is from about 0.05 to about 0.25; z is from 0 to about 0.95; M is selected from the class consisting of iron, cobalt, an iron-cobalt alloy; an iron-manganese alloy; an iron-cobalt-manganese alloy, X is a glass former selected from the class consisting of P, As, Ge, Ga, In, Sb, Bi, Sn, C, Si and Al; R is higher-weight lanthanide (Eu or heavier) and L is a lower-weight lanthanide selected from the group consisting of La, Ce, Pr, Nd and Sm.

The coercivity of the obtained polycrystalline alloys is about from 1 kOe up to 9 kOe. However these alloys are hard magnetic alloys and used as permanent magnets.

U.S. Pat. No. 5,757,272 discloses a strip or wire for an anti-theft or identification system that produces a definite signal with low switching field strengths and has a definite impulse behavior due to sudden reversal of its magnetization direction as a result of Barkhausen jumps. This elongated member is made from an amorphous material consisting of an alloy that satisfies the formula: CoₐNi_{b}(Fe,Mn)_{c}(Si,B,X)_{d}, wherein, in atomic %, a=20-85; b=0-50; c=0-15 and d=15-30, a+b+c+d=100, and wherein X designates at least one element selected from the group consisting of the transition metals of groups IIIB-VIB of the Periodic Table and one or more elements of the main groups IIIA-VA of the Periodic Table.

The obtained strip or wire is a soft magnetic material having the coercivity about 1 A/m. A disadvantage of the obtained material is the fact that the possible variations of this parameter are slight and independent of alloy composition.

Another disadvantage of this alloy is the fact that content of such modifiers as V, Cr, Zr and Nb is about 15-30%. In this case during the glass coated microwire casting process for elements of groups IIIB-VIB and IIIA-VA the following negative events may occur:

1. If the amount of modifiers is more then 8%, the solubility limit of such elements in the Fe-base alloys is increased. Isolated unstable phases such a Fe—V, Fe—Cr and etc. are formed. That leads to destruction of the magnetic phase in the soft magnetic alloy and a sharp decrease the magnetic permeability and other magnetic properties.

2. The isolated phases interact with the glass components and the interfacial tension in the system of metal-glass also is strongly increased. These conditions render impossible a stable microwire casting process.

3. Formation of the unstable isolated phases leads to embrittlement of the alloy and the brittleness of the microwire is increased.

U.S. Pat. No. 6,708,880 B1 discloses an amorphous ferromagnetic filament which comprises constituents selected from the group consisting of Co, Fe, Si, B, Mo, Zr, Ge Cr, Ni, Mn, V, Ti and C, with between 18 and 35% of (Si+B) and more than 40% of Co or Fe. The content in the ferromagnetic filaments of Ni, Mo, Zr, Ge, Cr, Mn, V, Ti, C is lower than 7%. These ferromagnetic filaments have a saturation field of between at least 320 A/m and 1700 A/m.

The above-mentioned materials have the following disadvantages:

1. The refiners, for example, Ce, La, Y, are absent. In this case such elements as Cr, Zr and V act as deoxidizers and purify the alloy from gas inclusions. Usually the magnetic permeability of the alloy is sharply decreased.

2. The amount of Si and B ranges between 18-35%. Such a concentration of amorphizator leads to sharp increase of interfacial tension and a stable microwire process is impossible. Moreover in this case the microwire is extremely brittle.

U.S. Pat. No. 6,270,591 B1 discloses amorphous glass-coated magnetic wire based on the transition metals Fe, Co and/or Ni; metalloids such as B, Si, C and/or B; and additional metals such as Cr, Ta, Nb, V, Cu, Al, Mo, Mn, W, Zr, Hf. The amounts of the transitions metals and metalloids is chosen to obtain alloys with high saturation magnetization; positive, negative or nearly zero magnetostriction; and coercive field and magnetic permeability having adequate values in relation to requested applications.

A disadvantage with these amorphous alloys is that wires of the alloys have an insufficient tensile strength because of insufficient purification of the alloys from entrapped gas and other non-metallic inclusions. Non-metallic inclusions are stress concentrators in the metal core of a microwire.

Moreover the presence of the refiners leads to possibility of providing a continuous stable microwire casting process.

U.S.S.R. Inventor's Certificate No. 1542078 discloses a soft magnetic alloy for glass-coated microwire casting having the following composition, in weight %:

Fe—base

Co: 12-18%,

Cr: 8.5-13.8%,

Si: 2.8-4.5%,

B: 2.2-3.6%, and

Y: 0.8-1.8%.

This alloy has a coercivity about 2-40 A/m and thermo stability under 380° C. The maximum length of the obtained microwire is about 300 m.

U.S.S.R. Inventor's Certificate No. 1138428 discloses a soft magnetic alloy for glass-coated microwire casting having the following composition, in weight %:

Fe: the base,

Ni: 42-43,

W: 1.2-2.0,

C: 0.1-0.25,

Cr: 1.7-2.3,

Mn: 3.2-4.8,

Si: 3.8-4.2,

B: 3.2-4.0,

Ce: 0.5-1.2, and

La: 0.2-0.8.

The coercive force of the proposed alloy is about 4-20 A/m. The thermo stability is about 320° C. and the maximum length of microwire is 500 m.

Alloys presented by the above-mentioned inventor's certificates have improved wetting between the glass and metal core. However, the alloys do not satisfy the following requirements:

1. controlled soft magnetic composition of the alloy;

2. fabrication of microwire having long continuous length (because of insufficient purification of the alloy from the entrapped gas and other non-metallic inclusions);

3. stable casting process (because of insufficient wetting ability of glasses by metal melt);

4. variation of coercivity (0.5-1200 A/m); and

5. high temperature stability (not less than 600° C.) for realization of a final thermo treatment at the higher temperature and low isothermal storage.

### SUMMARY OF THE INVENTION

Despite the extensive prior art in the area of glass-covered microwires, there is still a need for further improvements in microwire composition and properties. In particular it is desirable that a microwire obtained by a casting production process have excellent magnetic characteristics and a wide range of coercive force. It is also desirable to produce long continuous microwires having good mechanical properties.

The present invention satisfies the aforementioned need by providing a novel amorphous alloy on a base of Fe, Co and Ni and containing at least one of such elements as V, Cr Zr, Nb, Dy; additional elements Si and/or B; and rare-earth elements such as Ce, La and Y.

According to one embodiment of the invention, the amorphous alloy obtained by microwire casting technique contains
26 to 52 weight % Fe;
26 to 52 weight % Co;
3.0 to 38.0 weight % Ni;
at least one selected from the group consisting of
   1.0 to 8.0 weight % V,
   1.0 to 8.0 weight % Cr,
   1.0 to 8.0 weight % Zr,
   1.0 to 8.0 weight % Dy and
   1.0 to 8.0 weight % Nb;
at least one selected from the group consisting of
   2.0 to 8.3 weight % Si and
   2.0 to 8.3 weight % B; and
at least one selected from the group consisting of
   0.2 to 1.6 weight % Ce,
   0.2 to 1.6 weight % La and
   0.2 to 1.6 weight % Y,

According to another embodiment of the present invention, varying the content of such elements as V, Cr, Zr, Dy and/or Nb in the alloy provides the alloy with a wide coercivity range.

The alloy according to the present invention contains the four groups of components:

1. Fe, Co, Ni, which create the magnetic phase in the alloy. These components provide the required level of the main characteristic of the soft magnetic alloy—magnetic permeability;

2. Si and B—components that decrease the interphase tension between the melt of glass and metal. This results in good wetting ability of silica-boride glasses by metal melt during the microwire casting process;

3. Ce, La, Y—curative agents of the rare earths provide sufficient purification of the alloy mainly from entrapped gas (oxygen, nitrogen and hydrogen) and other non-metallic inclusions. Only the complex introduction of such elements provides reliable purification.

4. V, Cr, Zr, Nb, Dy—modifiers, i.e., components providing a variation in performance objectives, in particular, microwire coercive force.

### BRIEF DESCRIPTION OF THE DRAWINGS

In order to understand the invention and to see how it may be carried out in practice, a preferred embodiment will now be described, by way of non-limiting example only, with reference to the accompanying drawing, in which:

FIG. 1 is a schematic illustration of a system for mass manufacture of continuous lengths of glass-coated microwire, according to one embodiment of the invention.

### DETAILED DESCRIPTION OF THE PREFERRED EMBODIMENTS

The principles and operation of the process and apparatus according to the present invention may be better understood with reference to the drawing and the accompanying description, wherein like reference numerals have been used throughout to designate identical elements. It is understood that the drawing is given for illustrative purposes only and is not meant to be limiting.

According to one embodiment of the invention, the development of an alloy composition is carried out on a base of Fe, Co and Ni. A relationship between the components is the following, by weight %:

Fe and Co: 26.0-52.0; and

Ni:3.0-38.0.

This ratio of the elements corresponds to the maximum magnetic permeability of soft magnetic alloys base on the Fe—Co—Ni system, which ranges from 12000 up to 40000.

At the same time according to another embodiment of the invention the weight ratio between Fe and Co (Fe/Co) is in a range of from 0.4 to 2.1, or in a range of from about 1 to about 2, and the amount of Ni is selected based on the required value of magnetic permeability. The effect of the permeability enhancement is obtained when the amount of Ni in the alloy content is increased. When the optimal content of Fe, Co and Ni that corresponds to the above example is upset, the magnetic phase is decreased in the matrix and magnetic permeability is sharply reduced (up to 1000).

According to another embodiment of the invention the elements Si and B, each in amounts of 2.0-8.3 weight %, are introduced into the alloy. The given amounts of Si and B are chosen for the above-mentioned Fe—Co—Ni system. These elements are used to enhance the wetting of borosilicate glasses by a melt of the alloy, and to provide an amorphous structure in the alloy due to the fact that such elements are amorphizators.

The weight ratio of Si to B (Si/B) can be in a range of from about 1 to about 2. The optimum weight ratio of Si to B (Si/B) is 1. It is possible to modify the interfacial tension between the alloy and borosilicate glass if the weight ratio of Si to B is 2. The effect of the wetting is practically lacking when the content each element of Si and B is less than 2.0%. However when the content each element of Si and B is higher than 8.3%, X-ray tests show the brittleness of the microwire. In this case investigations show that borides of Fe and Co are formed as an independent phase and microwire longer than 100 m cannot be obtained.

Microwires fabricated from the composition of (Fe, Co, Ni)—(Si, B) have a magnetic permeability of up to 40 000. However the coercive force of these microwires is not more than 8 A/m.

According to a yet further embodiment of the invention, in order to vary the coercivity of the microwire elements such as at least one of V, Cr, Zr, Dy and Nb, each in the amount of 1.0-8.0 weight %, is introduced into the alloy. When the content of each of these components is 1.0% or higher, an increase in the coercivity is obtained. However if the content of each of these components is higher than 8.0% the coercive force sharply decreases. It should be noted that introduction of these elements into the alloy is effective if refiners such as Ce, La and Y are also introduced.

The influence mechanism of these components is identical. In order to select one or more components for alloying it is necessary to define the adjacent requirements for manufactured microwires (mechanical strength, thermo stability, cost).

The elements may be ordered in accordance with the decreasing their performance characteristics as follows:

Mechanical strength: Cr, Dy, Nb, V, Zr.

Thermostability: Nb, Cr, Dy, Zr, V

Cost: Dy, Cr, V, Nb, Zr.

It should be noted that for optimization of the alloy composition a combined alloying may be used, but the elements are added to the alloy only in the above mentioned ranges.

According to a further embodiment of the invention, an improvement in microwire manufacturing technology that provides an increase in the continuous length of microwire is attained by means of intensive purification of the alloy and elimination of gas and other nonmetallic inclusions, e.g., oxygen, hydrogen and nitrogen, and their compounds. For the purpose of effective purification, the complex introduction of small amounts of elements having the best affinity for these gases is preferred.

Examples of elements that have the best affinity to oxygen, hydrogen and nitrogen include, but are not limited to, Ce for oxygen, La for hydrogen, and Y for nitrogen. These examples of the elements are chosen for reasons of non-toxicity, chemical activity and technological ability.

According to one example, for optimization of the alloy composition only the complex introduction of elements is realized, in which each element is added to alloy in the following content, by weight %:

Ce, La, Y: 0.2-1.6%.

When the content of these elements is less than that in the above example, the purification effect is not obtained. On the other hand, when the content each of these elements is larger than 1.6%, these ingredients exude into isolated phases in the form of oxides, nitrides and nitrites. As a result a large amount of these compounds are formed at the zone of the microwire casting process. These compounds can lead to interruption of the casting process. It should be noted that the compulsory use of simultaneous complex alloying by Ce, La and Y is possible. The optimum weight ratio of these components is about 1:1:1.

According to the further aspect of invention, introduction of such refiners as Ce, La and Y provides a stable casting process (continuous process, stable diameters of microwire, short alignment time), which is very important for micron diameter wire. Moreover the fining of the alloys provides an increase in the mechanical strength of microwire due to the elimination of non-metallic inclusions that concentrate stress and destroy amorphous structure in the metal core of a microwire. For example, the tensile strength of the microwire without the fining of alloy is about 500-800 MPa. Due to fining of alloy by such elements as Ce, La, Y the tensile strength is multiplied by 1.8-2.0 and can be 1000-1600 MPa.

Representative metal glass alloys prepared in accordance with the present invention are listed in Table 3, along with the coercivity of each alloy. The measurement results presented in Table 3 show that depending upon alloy composition the coercivity can vary greatly.

TABLE 3

| | Chemical composition, weight % | | | | | | | | | | | | Coercivity |
|---|---|---|---|---|---|---|---|---|---|---|---|---|---|
| No | Fe | Co | Ni | V | Cr | Zr | Nb | Si | B | Ce | La | Y | Hc, A/m |
| 1 | 26.0 | 52.0 | 3.0 | 1.0 | 1.0 | 1.0 | 1.0 | 7.2 | 7.2 | 0.2 | 0.2 | 0.2 | 0.5 |
| 2 | 52.0 | 26.0 | 3.0 | 1.0 | 1.0 | 1.0 | 1.0 | 7.2 | 7.2 | 0.2 | 0.2 | 0.2 | 140 |
| 3 | 39.0 | 39.0 | 3.0 | 1.0 | 1.0 | 1.0 | 1.0 | 7.2 | 7.2 | 0.2 | 0.2 | 0.2 | 560 |
| 4 | 36.7 | 36.7 | 18.0 | 1.0 | 1.0 | 1.0 | 1.0 | 2.0 | 2.0 | 0.2 | 0.2 | 0.2 | 880 |
| 5 | 26.7 | 26.7 | 38.0 | 1.0 | 1.0 | 1.0 | 1.0 | 2.0 | 2.0 | 0.2 | 0.2 | 0.2 | 1200 |
| 6 | 26.0 | 26.0 | 11.4 | 8.0 | 8.0 | 8.0 | 8.0 | 2.0 | 2.0 | 0.2 | 0.2 | 0.2 | 930 |
| 7 | 34.0 | 34.0 | 11.4 | 4.0 | 4.0 | 4.0 | 4.0 | 2.0 | 2.0 | 0.2 | 0.2 | 0.2 | 670 |
| 8 | 28.0 | 28.0 | 3.0 | 8.0 | 8.0 | 8.0 | 8.0 | 8.3 | 8.3 | 1.6 | 1.6 | 1.6 | 290 |
| 9 | 26.0 | 26.0 | 11.6 | 5.0 | 5.0 | 5.0 | 5.0 | 5.6 | 5.6 | 1.6 | 1.6 | 1.6 | 780 |
| 10 | 26.0 | 26.0 | 19.6 | 5.0 | 5.0 | 5.0 | 5.0 | 4.0 | 2.0 | 0.8 | 0.8 | 0.8 | 980 |
| 11 | 26.0 | 26.0 | 15.6 | 5.0 | 5.0 | 5.0 | 5.0 | 8.0 | 4.0 | 0.8 | 0.8 | 0.8 | 790 |
| 12 | 26.0 | 26.0 | 3.0 | 8.0 | 8.0 | 8.0 | 8.0 | 4.8 | 2.4 | 0.6 | 0.6 | 0.6 | 570 |
| 13 | 52.0 | 26.0 | 3.0 | 3.3 | 3.3 | 3.3 | 3.3 | 2.0 | 2.0 | 0.6 | 0.6 | 0.6 | 70 |
| 14 | 26.0 | 52.0 | 3.0 | 3.3 | 3.3 | 3.3 | 3.3 | 2.0 | 2.0 | 0.6 | 0.6 | 0.6 | 190 |

The alloys are melted in alundum crucibles by a high frequency inductor at 880 KHz.

According to one embodiment of the invention, the ingredients are added in the following order:

1. Iron, cobalt and nickel;

2. Chromium, niobium, vanadium, dysprosium and zirconium are added in series after melting of the Fe—Co—Ni system;

3. Silicon and boron are added in the needed ratio; and

4. Cerium, lanthanum and yttrium are introduced.

A glass coated microwire with an amorphous metal core is produced by providing a glass tube containing the desired metal and melting the metal in a high frequency induction field. The heat of the metal melt softens the glass tube and a thin capillary is drawn out from the softened glass tube. Thereafter, the metal-filled capillary enters a cooling zone where it is cooled such that the desired amorphous microwire is obtained. The optimal diameter of the obtained microwire is in the range of 3 to 75 microns.

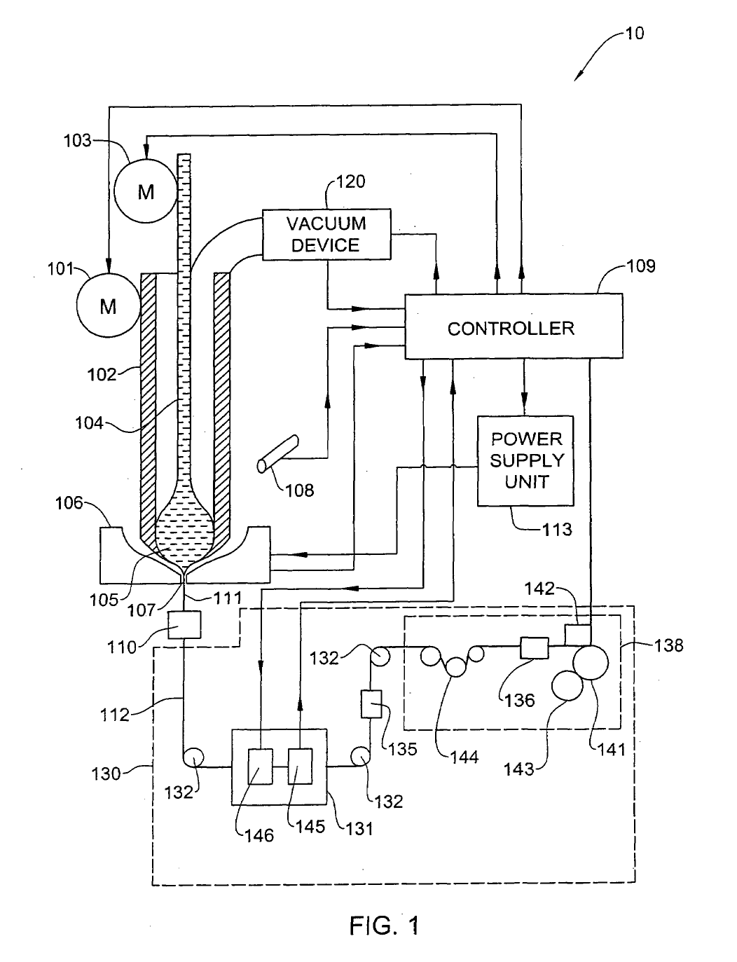

Referring to FIG. 1, a system for a mass manufacture of continuous lengths of glass coated microwire is shown in schematic form in order to illustrate the process according to one embodiment of the invention. It should be noted that the blocks in FIG. 1 are intended as functional entities only, such that the functional relationships between the entities are shown, rather than any physical connections and/or physical relationships. The system of FIG. 1, generally identified by reference numeral 10, includes a suitable glass feeder mechanism diagrammatically represented by a circle 101 for providing a supply of glass tubing 102. The system also includes a rod feeder mechanism diagrammatically represented by a circle 103 for providing a supply of a rod, bar or wire 104 made of a core material. It should be appreciated that the mechanisms 101 and 103 can be both configured in one feeder device that may serve a multiple function for providing a supply of glass and core materials. The glass feeder mechanism 101 is controllable by a glass feeder signal and includes a driving motor (not shown) which acts on the glass tubing 102 for providing a supply of a glass material with a required speed. By the same token, the rod feeder mechanism 103 is controllable by a rod feeder signal and includes a driving motor (not shown) which acts on the rod 104 for providing a supply of a core material with a required speed. The glass and rod feeder signals are generated by a controller 109 configured to control the system 10.

Examples of the glasses of the glass tubing 102 include, but are not limited to, glasses with a large amount of oxides of alkali metals, borosilicate glasses, aluminosilicate glasses, etc. It should be understood that various alternative glasses may be selected by one skilled in the art for the particular desired application and environment in which the coated wire composite is to be used.

A tip of the glass tubing 102 loaded with the rod 104 is introduced into a furnace 106 adapted for softening the glass material making up the tubing 102 and melting the rod 104 in the vicinity of the exit orifice 107, such that a drop 105 of the wire material in the molten state is formed.

The furnace 106 includes at least one high frequency induction coil, e.g. one wind coil. The operation of the furnace 106 is known per se, and will not be discussed in detail below.

An exemplary furnace that has been shown to be suitable for the manufacturing process of the present invention is the Model HFP 12, manufactured by EFD Induction Gmbh, Germany.

The temperature of the drop is measured by a temperature sensor pointing at the hottest point of the drop and diagrammatically represented by a box 108. An example of the temperature sensor includes, but is not limited to, the Model Omega OS1553-A produced by Omega Engineering Ltd.

The temperature sensor 108 is operable for producing a temperature sensor signal. The temperature sensor 108 is coupled to the controller 109 which is, inter alia, responsive to the temperature sensor signal and capable of providing a control by means of a PID loop for regulating the temperature of the drop 105 for stabilizing and maintaining it at a required magnitude. For example, the temperature of the drop can be maintained in the range of 800° C. to 1500° C.

It should be appreciated that one way of regulating the drop temperature is the regulation of the temperature of the furnace 106 by changing the furnace's power consumption. For this purpose, controller 109 is capable of generating a furnace power signal, by means of a PID control loop, to a power supply unit 113 of the furnace 106. For example, when the consumption power increases, the drop temperature should also increase, provided by the condition that the position of the drop 105 does not change with respect to the furnace 106. However, since the furnace includes a high frequency induction coil, the increase of the consumption power leads to the elevation of the drop, due to the levitation effect. Hence, the temperature of the drop depends on many parameters and does not always change in the desired direction when only the consumption power is regulated.

An example of the power supply unit 113 includes, but is not limited to the Mitsubishi AC inverter, Model FR-A540-11k-EC, Mitsubishi, Japan.

The compensation of the levitation effect is accomplished by regulation of the gas pressure in the tubing 102. Thus, in order to avoid the droplet elevation due to the increase of the consumption power, the negative gas pressure (with respect to the atmospheric pressure) is decreased to a required value calculated by the controller 109.

For this purpose, the system 10 is further provided with a vacuum device identified by reference numeral 120 for evacuating gas from the tubing 102. The vacuum device 120 is coupled to the tubing 102 via a suitable seal able coupling element (not shown) so as to apply negative gas pressure to the inside volume of the tube 102 while allowing passage of the rod 104 there through.

The vacuum device 120 is controllable by a vacuum device signal generated by the controller 109 for providing variable negative pressure to the molten metal drop in the region of contact with the glass. The pressure variation permits the manipulation and control of the molten metal in the interface with the glass in a manner as may be suitable to provide a desirable result.

The system 10 is further provided with a cooling device 110, arranged downstream of the furnace 106 and adapted for cooling a microwire filament 111 drawn out from the drop 105. The microwire filament 111 can be drawn at a speed in the range of 5 m/min to 1500 m/min through the cooling device 110. The cooling device 110 is built in such a way that the filament 111 being formed passes though a cooling liquid where it supercools and solidifies, and thereafter proceeds as a microwire 112 towards a receiver section 130 arranged downstream of the cooling device 110.

The receiver section 130 for microwire 112 comprises a spooler 138 for collecting the finished microwire product. The spooler 138 includes at least one receiving spool 141, a spool diameter sensor 142, a drive motor assembly 143 and a guide pulley assembly 144. The spool diameter sensor is configured for measuring an effective core diameter of the spool and generating a spool diameter sensor signal representative of the value of the spool diameter.

The drive motor assembly 143 is controllable by a spool speed signal generated by the controller 109 for rotating the spool with a required cyclic speed in response to the spool diameter sensor signal. The cyclic speed is regulated in order to maintain the linear speed of the microwire at the desired value.

The receiver section 130 can further include a tension unit 131 having a tension sensor 145 configured for generating a tension sensor signal.

The tension unit 131 includes a tension generator 146 controllable by a wire tension signal produced by controller 109 in response to the tension sensor signal. The tension generator 146 is arranged to create tension of the microwire.

The receiver section 130 can also include a wax applicator 136 for waxing the microwire. The system 10 can also include a micrometer 135 arranged downstream of the tension unit 131 and configured for measuring the microwire overall diameter, length and other parameters, e.g., microwire speed. The micrometer 135 is configured for producing, inter alia, a wire diameter sensor signal representative of the microwire overall diameter. The micrometer 135 is operatively coupled to the controller 109 that is responsive to the diameter sensor signal and operable for generating a corresponding signal for regulating, inter alia, the drop temperature, for stabilizing the overall microwire diameter.

The receiver section 130 also includes a required number of guide pulleys 132 arranged for providing a required direction to the microwire.

The disclosure of a range of numbers herein is to be considered the disclosure of every number within that range.

1. An alloy, which can be used in a microwire, the alloy comprising
26 to 52 weight % Fe;
26 to 52 weight % Co;
3.0 to 38.0 weight % Ni;
at least one selected from the group consisting of
1.0 to 8.0 weight % V,
1.0 to 8.0 weight % Cr,
1.0 to 8.0 weight % Zr,
1.0 to 8.0 weight % Dy and
1.0 to 8.0 weight % Nb;
at least one selected from the group consisting of
2.0 to 8.3 weight % Si and
2.0 to 8.3 weight % B; and
at least one selected from the group consisting of
0.2 to 1.6 weight % Ce,
0.2 to 1.6 weight % La and
0.2 to 1.6 weight % Y, wherein
the alloy is substantially amorphous.

2. The alloy according to claim 1, wherein the alloy has a coercivity in a range of 0.5 to 1200 A/m.

3. The alloy according to claim 1, wherein a weight ratio of Fe to Co (Fe/Co) is in a range of from 0.4 to 2.1.

4. The alloy according to claim 3, wherein the weight ratio of Fe to Co (Fe/Co) is about 0.5 or about 1.

5. The alloy according to claim 1, wherein a weight ratio of Si to B (Si/B) is in a range of from about 1 to about 2.

6. The alloy according to claim 1, wherein a weight ratio of Ce:La:Y is about 1:1:1.

7. The alloy according to claim 1, wherein the alloy has a tensile strength in the range of from 1000 to 1600 MPa.

8. The alloy according to claim 1, wherein the alloy is a soft magnetic alloy.

9. The alloy according to claim 1, wherein the alloy is amorphous.

10. The alloy according to claim 1, wherein the substantially amorphous alloy is produced by a process comprising quenching a molten alloy with water.

11. The alloy according to claim 1, wherein the alloy is in the form of a wire and is coated with a glass.

12. A method of making an alloy, the method comprising
melting together Fe, Co, Ni; at least one selected from the group consisting of V, Cr, Zr, Dy and Nb; at least one selected from the group consisting of Si and B; and at least one selected from the group consisting of Ce, La and Y to form a melt,
quenching the melt, and
producing the alloy of claim 1.
